(19) United States
(12) Patent Application Publication
(10) Pub. No.: US 2006/0219288 A1
(43) Pub. Date: Oct. 5, 2006

(54) Process and photovoltaic device using an akali-containing layer

(75) Inventor: John R. Tuttle, Mechanicville, NY (US)

Correspondence Address: HISCOCK & BARCLAY, LLP, 2000 HSBC PLAZA, ROCHESTER, NY, 14604-2404, US

(73) Assignee: DayStar Technologies, Inc.

(21) Appl. No.: 11/272,185

(22) Filed: Nov. 10, 2005

Related U.S. Application Data
(60) Provisional application No. 60/626,843, filed on Nov. 10, 2004.

(51) Int. Cl. H02N 6/00

(52) U.S. Cl. 136/243

(57) ABSTRACT

This invention describes the product and method of developing a photovoltaic device using an alkali-containing mixed phase semiconductor source layer to enhance cell efficiency and minimize molecular structure defects.

### CROSS-REFERENCE TO RELATED APPLICATIONS

This application claims priority from U.S. Provisional Patent Application Ser. No. 60/626,843, filed Nov. 10, 2004.

### FIELD OF THE INVENTION

This invention relates to the formation of thin-film photovoltaic device using an alkali-containing mixed phase semiconductor source layer.

### BACKGROUND OF THE INVENTION

Alternative energy sources such as photovoltaic (PV) cells, modules, and power systems offer clean, reliable, renewable energy to the world's expanding demand for power. However, to a large extent higher than desired product costs and lower than desired production capacities have relegated photovoltaics to niche markets only. With the demand for energy going up, the world demand for alternatives to present energy sources is increasing.

PV technologies offer a clean, non-carbon based alternative to traditional, non-renewable energy sources. The performance of a PV cell is measured in terms of its efficiency at converting light power into electrical power. Even though relatively efficient PV cells can be manufactured in the laboratory, it has proven difficult to produce PV cells on a commercial scale at the appropriate cost-basis critical for commercial viability. This problem has its roots in several factors, none the least of which is optimizing electrical output while, at the same time, minimizing cost and weight. Furthermore, any PV product must be sufficiently effective so as to be applicable in real world energy markets.

In an attempt to lower costs, a reduction in the total thickness of the solar cell has been pursued for over two decades. The primary solar cell technology today is made of crystalline Silicon (Si). Typical Si cell thicknesses range from 150 microns to 300 microns. Since Si is an “indirect” bandgap semiconductor, its thickness cannot be reduced much below 150 microns or the cell efficiency will decrease. On the other hand, there are other semiconductor materials suitable for solar cell applications that are “direct” bandgap semiconductors and can hence absorb the solar spectrum with significantly less thickness of solar cell material. This family of materials is often referred to as “thin-film” solar cells. Thin-film solar cells are typically 1-5 microns thick and hence offer the potential for tremendous raw material savings relative to Si solar cells.

In a thin-film solar cell, the p-n junction is typically created with dissimilar materials—a p-type absorber and an n-type window. Once such p-type absorber is comprised of the family of materials consisting of elements from the columns I, III, and VI of the periodic table.

One of the most effective of these compositions is an absorber made of compounds comprising the elements copper, indium, gallium and selenium, in various ratios. Use of this composition became so prevalent that PV cells of this makeup are now known as CIGS (Cu:In:Ga:Se) photovoltaic cells.

The best CIGS solar cells are fabricated on soda-lime glass and demonstrate greater than 19% conversion efficiency in the laboratory setting. It has been empirically determined that the high efficiency is partially a consequence of alkali metals, particularly sodium, diffusing out of the glass and into the CIGS absorber layer during the deposition process. The degree of out-diffusion of alkali metals from the glass and into the CIGS absorber layer is, in part, related to the thermal budget of the deposition process. The thermal budget is related to both the magnitude and duration of the processing temperatures. The coupling of the final alkali metal content in the CIGS absorber with the processing conditions during deposition is not conducive to a desired reproducibility and manufacturing control. Therefore, those skilled in the art of fabricating CIGS PV cells on soda-lime glass substrates have learned to control the alkali content by first introducing an alkali barrier layer between substrate and the metallic back contact to prevent the out-diffusion of alkali species, and subsequently depositing a known thickness of an alkali-containing compound between the back contact and the CIGS semiconductor.

If the substrate of choice does not contain an alkali species, such as a metal or plastic, then those skilled in the art recognize the requirement of adding a controlled amount of an alkali metal in order to achieve the highest possible solar cell performance. In particular, the addition of alkali metals enables CIGS films to achieve a larger grain size, a more strongly oriented texture, an increased carrier concentration, and a higher conductivity. Since all of these properties are advantageous to creating an enhanced PV cell, the addition of an alkali metal such as sodium to a CIGS layer is desired in the art.

Until now, the incorporation of an alkali metal into CIGS absorbers has been difficult to achieve in actual practice, due to some particularities of the deposition process. Specific concerns include: determining at what the point in the deposition process the alkali metal should be added so as not to negatively affect adhesion of the CIGS film to the metallic back contract; what compound should be used to deliver the alkali metal, as elemental alkali metals are highly reactive and require special handling considerations; and what environmental conditions in the deposition process are necessary to achieve a successful level of alkali metal incorporation into the semiconductor material. To address these concerns, a viable process for the incorporation of alkali metal such as sodium in a CIGS absorber layer is desired in the art.

While the addition of sodium has been contemplated in other references, a practical method by which a sodium based alkali materials are added during the formation process has not yet been taught. For example, U.S. Pat. No. 6,881,647, issued to Stanbery on Apr. 19, 2005 (“Stanbery”), discloses the use of a sodium precursor layer as a surfactant for the adhesion of two layers in the development of a CIGSS (Cu:In:Ga:S:Se) device. However, Stanbery does not disclose the principle of depositing alkali materials prior to deposition of a semiconductor layer with a subsequent thermal treatment.

U.S. Pat. No. 6,323,417, issued to Gillespie et al. on Nov. 27, 2001 (“Gillespie”) discloses the development of a CIGS-type PV cell using deposition methods, and acknowledges that sodium may be added to change absorber properties. However, Gillespie does not disclose a method for achieving this design, nor a process by which to form a sodium doped CIGS-type absorber. Therefore, a viable process to form a sodium doped CIGS-type absorber is necessary to achieve the full measure of advantages in the art.

U.S. patent application Ser. No. 10/942,682 by Negami et al. (“Negami”) discloses sputtering NaP or NaN either before the precursor, after the precursor, or mixed. However, Negami's process involves temperatures of up to 800° C. which would make manufacturing problematic and difficult. Therefore an alternative process that is safer and provides for a lower cost to manufacture is required in the art.

Additionally, there does not exist in the present art a methodology for introducing alkali materials into a CIGS absorber layer while simultaneously improving the adhesion of the CIGS layer to the metallic back contact, nor does there exist a device that includes an electron “mirror” to reduce minority carrier recombination in the CIGS absorber resulting in enhanced performance.

### SUMMARY OF THE INVENTION

This invention comprises a mixed-phase semiconductor layer, or source layer, in a photovoltaic device (PV) where the mixed-phase semiconductor layer comprises a mixture or an alloy of alkali materials and I-III-VI₂ compound. This layer is used in conjunction with a conducting back contact layer and another I-III-VI₂ compound absorber layer. The most commonly known I-III-VI₂ compound for such semiconductors comprises some combination of copper, indium, gallium and selenium, forming a compound commonly known to those skilled in the art as CIGS. The most common alkali materials comprise some combination of sodium, potassium, fluorine, selenium and sulfur. More specifically, the most common alkali materials used for this purpose are NaF, Na₂Se and Na₂S. However, unlike other references, this invention includes a process where an alkali material is combined with a I-III-VI₂ semiconductor material, preferably of a band gap that is higher than the CIGS absorber layer, to form a mixed-phase semiconductor source material that is introduced between the conducting back contact layer and the CIGS absorber layers.

In one form, the invention is a mixed phase semiconductor source layer that is comprised of a mixture of a alkali materials and pre-reacted I-III-VI precursor metals to form a mixed-phase semiconductor source layer.

In another form, the invention is a mixed phase semiconductor source layer that is comprised of a mixture of alkali materials and unreacted I, III and VI precursor metals that are subsequently reacted into a I-VII:I-III-VI or (I)2VI:I-III-VI alloy. The reaction step could be separate from or concurrent with the reaction step that is used to form the CIGS absorber layer.

In one form, the invention is a method for the creation of a mixed phase semiconductor source layer for a photovoltaic device made, in part, by the deposition of mixed-phase semiconductor layer or alloy derived from a source material comprising alkali metals in conjunction with a I-III-VI semiconductor compound.

In another form, the invention is a method for the creation of a mixed-phase semiconductor source layer for a photovoltaic device made, in part, by the co-deposition of two source materials, one of which is comprised of alkali metals and the other of which is comprised of either a reacted I-III-VI compound or an unreacted precursor comprised of the I, III, and VI elements, or alloys or reacted binary compounds thereof.

In yet another form, the invention is a method for creation of a mixed-phase semiconductor source layer for a photovoltaic device made, in part, by the sequential deposition of two source materials, the first of which is comprised of either a reacted I-III-VI compound or an unreacted precursor comprised of the I, III, and VI elements, or alloys or reacted binary compounds thereof, and the second of which is comprised of alkali metals. The two discrete layers are subsequently reacted, either separately or in conjunction with the formation of the CIGS absorber layer, to form a mixed-phase semiconductor source layer.

The substrate upon which the layers are deposited may be chosen from a group of materials comprising metal, plastic, glass and various polymer materials.

As shown in numerous references, CIGS semiconductors are formed through sequential or co-deposition of various compositions of I-III-VI metals upon a substrate. Some examples include CuGaS₂, CuInS₂, CuInTe₂, CuAlS₂, CuInGa, CuGaS₂, AgInS₂, AgGaSe₂, AgGaTe₂, AgInSe₂, and AgInTe₂. However, as mentioned above, the most common composition is the copper indium diselenide (CuInSe₂) variant or CIGS. Methods for deposition include sputtering, evaporation or other such processes known to those skilled in the art. The alkali materials are similarly deposited before the formation of the CIGS semiconductor. To complete the incorporation of the alkali metal into the semiconductor layer, there must be a thermal treatment either during the deposition process or at some point later, at a temperature of about 400° C. to about 600° C.

When the mixed phase semiconductor source layer is formed, typically to a thickness of about 150 nm to about 500 nm, the alkali metals constitute between 5.0 to about 15.0 wt %. The alkali-containing mixed phase semiconductor source layer then incorporates with another p-type I-III-VI semiconductor layer, through the atomic exchange of sodium and other I-III-VI elements when thermally treated at high temperatures.

### BRIEF DESCRIPTION OF THE DRAWINGS

The above-mentioned and other features and advantages of this invention, and the manner of attaining them, will become apparent and be better understood by reference to the following description of the embodiment of the invention in conjunction with the accompanying drawing, wherein:

FIG. 1A shows an embodiment of a thin-film solar cell produced by the production technology of the present invention.

FIG. 1B shows an example of synthesizing alkali materials with an I-III-VI compound to form a mixed-phase semiconductor layer.

FIG. 1C shows another example of synthesizing alkali materials with an I-III-VI compound to form a mixed-phase semiconductor layer.

FIG. 1D shows another example of synthesizing alkali materials with an I-III-VI compound to form a mixed-phase semiconductor layer.

FIG. 1E shows another example of synthesizing alkali materials with an I-III-VI compound to form a mixed-phase semiconductor layer.

FIG. 1F shows another example of synthesizing alkali materials with an I-III-VI compound to form a mixed-phase semiconductor layer.

Corresponding reference characters indicate corresponding parts throughout the several views. The examples set out herein illustrate six embodiments of the invention but should not be construed as limiting the scope of the invention in any manner.

### DETAILED DESCRIPTION

The present invention details an aspect in the production of photovoltaic (PV) devices with the aim of increasing energy efficiency and maximizing device production. More advanced PV technology has utilized alloys comprised of periodic table group I, III and VI elements for more advanced light energy absorption. Specifically, this invention enhances the quality of a Cu:In:Ga:Se p-type absorber (CIGS) in a photovoltaic device through the integration of alkali metals, such as sodium, and a semiconductor layer. Like many related embodiments, the PV cells in this embodiment are created through the sequential deposition of discrete layers. Methods of deposition may involve techniques such as sputtering, evaporation or other related deposition methods known to those skilled in the art.

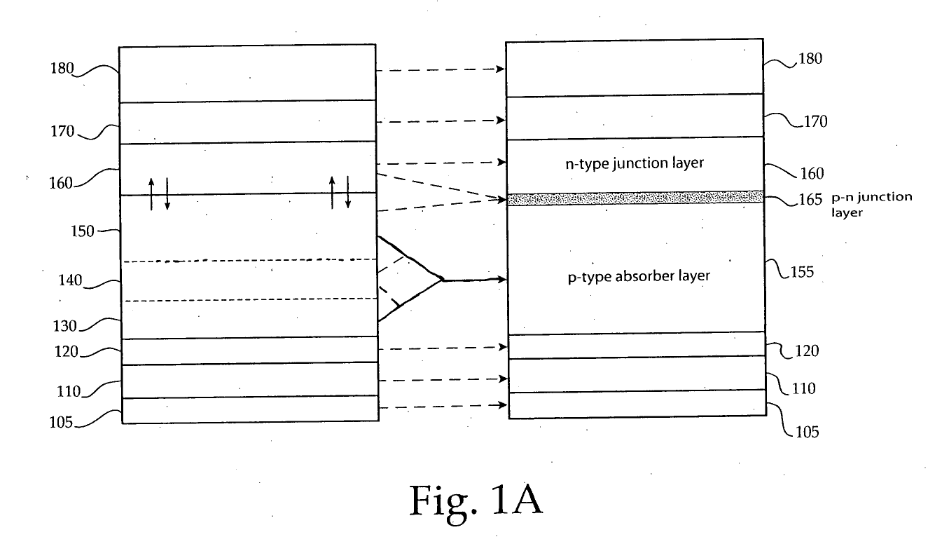

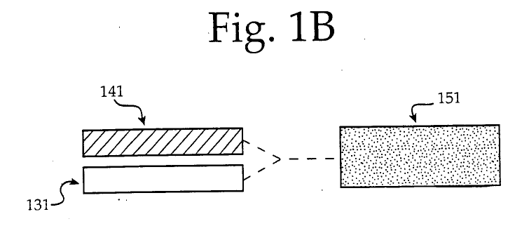

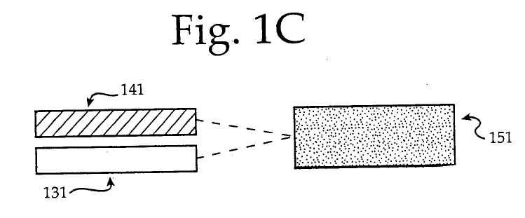

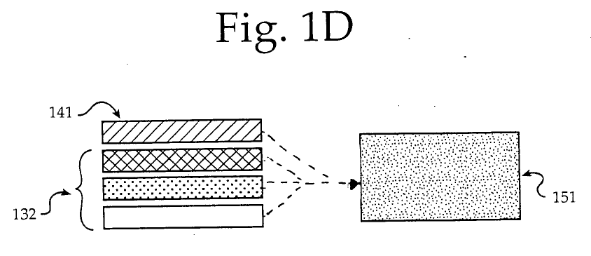

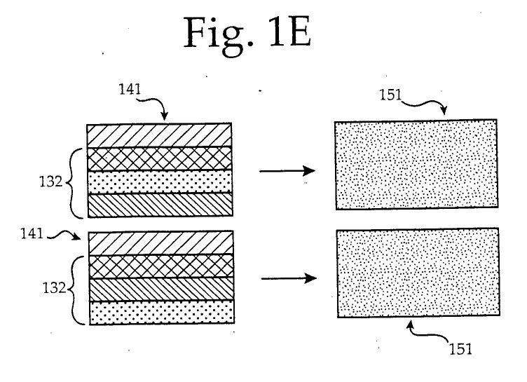

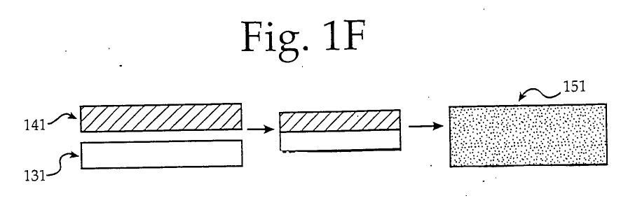

Viewing FIG. 1A, all layers are deposited on a substrate 105 which may comprise one of a plurality of functional materials, for example, glass, metal, ceramic, or plastic. Deposited directly on the substrate 105 is a barrier layer 110. The barrier layer 110 comprises a thin conductor or very thin insulating material and serves to block the out diffusion of undesirable elements or compounds from the substrate to the rest of the cell. This barrier layer 110 may comprise chromium, titanium, silicon oxide, titanium nitride and related materials that have the requisite conductivity and durability. The next deposited layer is the back contact layer 120 comprising non-reactive metals such as molybdenum. The next layer is deposited upon the back contact layer 120 is a semiconductor layer 130 to improve adhesion between an absorber layer and the back contact. This semiconductor layer 130 may be a I-IIIa,b-VI isotype semiconductor, but the preferred composition is Cu:Ga:Se; Cu:Al:Se or Cu:In:Se alloyed with either of the previous compounds.

In this embodiment, an alkali-containing mixed phase semiconductor source layer 155 is created by the interdiffusion of a number of discrete layers. Ultimately, as seen in FIG. 1A, a first semiconductor layer 130 and second semiconductor layer 150 combine to form a single composite p-type absorber layer 155, which serves as the prime absorber of solar energy. Unlike other embodiments, however, alkali materials 140 are added for the purpose of seeding the growth of subsequent layers as well as increasing the carrier concentration and grain size of the p-type absorber layer 155, thereby increasing the conversion efficiency of the PV device.

The alkali materials 140 are commonly sodium based and are usually deposited in the form of Na-VII (VII=F, Cl, Br) or Na₂-VI (VI=S, Se, Te). When deposited, the alkali materials 140 may be in the form of an Na-A:I-III-VI alloy (A=VI or VII) to allow for exchange of elements with the semiconductor layer 150.

As shown by FIG. 1A, the alkali material 140 is discrete, and the semiconductor layer 150 is deposited upon it. However, the alkali materials do not stay discrete, but rather integrate with the semiconductor layers 130 and 150 as part of the formation of the final p-type absorber layer as shown in 155. When deposited, the alkali materials are deposited onto the semiconductor layer 130 or other preexisting layer through evaporation, sputtering or other deposition method known to those skilled in the art. In the preferred embodiment, the alkali material 140 is sputtered at ambient temperature and at a mild vacuum, preferably 10⁻⁶-10⁻² torr.

In one embodiment, once the semiconductor layer 130 and the alkali materials 140 are deposited, and the layers are thermally treated at a temperature of about 400-600° C. to form a mixed phase semiconductor source layer.

After the thermal treatment, the photovoltaic production process is continued by the deposition of an n-type junction buffer layer 160. This layer 160 will ultimately interact with the semiconductor layer 150 to form the necessary p-n junction 165. A transparent intrinsic oxide layer 170 is deposited next to serve as a hetero-junction with the CIGS absorber. Finally, a conducting transparent oxide layer 180 is deposited to function as the top of the electrode of the cell. This final layer is conductive and may carry current to a grid carrier that allows the current generated to be carried away.

The process illustrated in FIG. 1A may be of different embodiments than the one described above. Viewing FIG. 1B, another example of creating the mixed phase semiconductor source layer described above is shown. In FIG. 1B, the I-III-VI semiconductor 131 and the alkali materials 141 are synthesized separately, then mixed, and then deposited on a substrate to form an Na:I-III-VI mixed phase semiconductor source layer 151. As discussed above, these alkali materials are added for the purpose of seeding the growth of subsequent layers, and the semiconductor layer is first deposited to create good adhesion to the back contact metal. When the I-III-VI precursor metals in these embodiments are deposited and selenized—and the alkali layer is consumed—the resulting mixed phase semiconductor source layer reacts to form the final p-type absorber layer.

Viewing FIG. 1C, an I-III-VI compound 131 and the alkali materials 141 are synthesized separately, then co-deposited on a substrate to form an Na:I-III-VI layer 151. As discussed above, the alkali materials are added for the purpose of seeding the growth of subsequent layers as well as increasing the carrier concentration and grain size of the absorber layer, thereby increasing the conversion efficiency of the solar cell.

Viewing FIG. 1D, I-III-VI precursor materials 132 and alkali materials 141 are co-deposited. Next, the I-III-VI precursor materials 132 and the alkali materials 141 are synthesized into an alloy mixture to form an Na:I-III-VI mixed phase semiconductor source layer 151.

Viewing FIG. 1E, I-III-VI precursor materials 132 and alkali materials 141 are sequentially deposited and then synthesized into an alloy mixture to form an Na:I-III-VI mixed phase semiconductor source layer 151. The alkali materials 141 may be deposited with one, all, or any combination of the precursor materials 132—in any sequential order—to form the Na:I-II-VI layer 151. Two of these possible combinations are illustrated by FIG. 1E.

Viewing FIG. 1F, the I-III-VI precursor materials 131 and the alkali materials 141 are first synthesized separately. Next, the I-III-VI materials 131 and the alkali materials 141 are sequentially deposited on a substrate. The I-III-VI material 131 and the alkali materials 141 are then alloyed with a thermal treatment a temperature of about 400° C.-600° C. to form an Na:I-III-VI mixed phase semiconductor source layer 151.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

What is claimed is:

1) A mixed phase semiconductor source layer for a photovoltaic device comprising a semiconductor layer and alkali materials wherein the semiconductor layer and the alkali materials are separately synthesized, and then mixed, and then deposited on a substrate.

2) The mixed phase semiconductor source layer of claim 1 wherein said semiconductor layer is formed by the delivery of type I, III, and VI precursor metals.

3) The mixed phase semiconductor source layer of claim 1 wherein said alkali materials are Na-VII or Na₂-VII.

4) The mixed phase semiconductor source layer of claim 1 wherein said mixture is deposited at ambient temperature and a pressure of 10⁻⁶-10⁻² torr.

5) The mixed phase semiconductor source layer of claim 1 wherein said mixture is thermally treated to a temperature of 400° C.-600° C.

6) The mixed phase semiconductor source layer of claim 1 wherein the thickness of said mixed phase semiconductor source layer is between 150 and 500 nm.

7) The mixed phase semiconductor source layer of claim 1 wherein said mixed phase semiconductor source layer contains an alkali metal content of 5.0 to about 15.0 wt %.

8) A mixed phase semiconductor source layer for a photovoltaic device comprising a semiconductor layer and alkali materials wherein the semiconductor layer and the alkali materials are separately synthesized, and then co-deposited on a substrate.

9) The mixed phase semiconductor source layer of claim 8 wherein said semiconductor layer is formed by the delivery of type I, III, and VI precursor metals.

10) The mixed phase semiconductor source layer of claim 8 wherein said alkali materials are Na-VII or Na₂-VII.

11) The mixed phase semiconductor source layer of claim 8 wherein said semiconductor layer and said alkali materials are deposited at ambient temperature and a pressure of 10⁻⁶-10⁻² torr.

12) The mixed phase semiconductor source layer of claim 8 wherein said semiconductor layer and said alkali materials are thermally treated at a temperature of 400° C.-600° C.

13) The mixed phase semiconductor source layer of claim 8 wherein the thickness of said mixed phase semiconductor source layer is between 150 and 500 nm.

14) The mixed phase semiconductor source layer of claim 8 wherein said mixed phase semiconductor source layer contains an alkali metal content of 5.0 to about 15.0 wt %.

15) A mixed phase semiconductor source layer for a photovoltaic device comprising a semiconductor layer and alkali materials wherein the semiconductor layer and the alkali materials are co-deposited on a substrate and then synthesized into an alloy mixture.

16) The mixed phase semiconductor source layer of claim 15 wherein said semiconductor layer is formed by the delivery of type I, III, and VI precursor metals.

17) The mixed phase semiconductor source layer of claim 15 wherein said alkali materials are Na-VII or Na₂-VII.

18) The mixed phase semiconductor source layer of claim 15 wherein said semiconductor layer and said alkali materials are deposited at ambient temperature and a pressure of 10⁻⁶-10⁻² torr.

19) The mixed phase semiconductor source layer of claim 15 wherein said semiconductor layer and said alkali materials are thermally treated at a temperature of 400° C.-600° C.

20) The mixed phase semiconductor source layer of claim 15 wherein the thickness of said mixed phase semiconductor source layer is between 150 and 500 nm.

21) The mixed phase semiconductor source layer of claim 15 wherein said mixed phase semiconductor source layer contains an alkali metal content of 5.0 to about 15.0 wt %.

22) A mixed phase semiconductor source layer for a photovoltaic device comprising a semiconductor layer and alkali materials wherein the semiconductor layer and the alkali materials are sequentially deposited and then synthesized into an alloy mixture.

23) The mixed phase semiconductor source layer of claim 22 wherein said semiconductor layer is formed by the delivery of type I, III, and VI precursor metals.

24) The mixed phase semiconductor source layer of claim 22 wherein said alkali materials are Na-VII or Na₂-VII.

25) The mixed phase semiconductor source layer of claim 22 wherein said semiconductor layer and said alkali materials are deposited at ambient temperature and a pressure of 10⁻⁶-10⁻² torr.

26) The mixed phase semiconductor source layer of claim 22 wherein said semiconductor layer and said alkali materials are thermally treated at a temperature of 400° C.-600° C.

27) The mixed phase semiconductor source layer of claim 22 wherein the thickness of said mixed phase semiconductor source layer is between 150 and 500 nm.

28) The mixed phase semiconductor source layer of claim 22 wherein said mixed phase semiconductor source layer contains an alkali metal content of 5.0 to about 15.0 wt %.

29) A mixed phase semiconductor source layer for a photovoltaic device comprising a semiconductor layer and alkali materials wherein the semiconductor layer and the alkali materials are synthesized separately, sequentially deposited on a substrate, and then alloyed with a thermal treatment.

30) The mixed phase semiconductor source layer of claim 29 wherein said semiconductor layer is formed by the delivery of type I, III, and VI precursor metals.

31) The mixed phase semiconductor source layer of claim 29 wherein said alkali materials are Na-VII or Na₂-VII.

32) The mixed phase semiconductor source layer of claim 29 wherein said semiconductor layer and said alkali materials are deposited at ambient temperature and a pressure of 10⁻⁶-10⁻² torr.

33) The mixed phase semiconductor source layer of claim 29 wherein said semiconductor layer and said alkali materials are thermally treated at a temperature of 400° C.-600° C.

34) The mixed phase semiconductor source layer of claim 29 wherein the thickness of said mixed phase semiconductor source layer is between 150 and 500 nm.

35) The mixed phase semiconductor source layer of claim 29 wherein said mixed phase semiconductor source layer contains an alkali metal content of 5.0 to about 15.0 wt %.

36) A method for the creation of a mixed phase semiconductor source layer for a photovoltaic device formed by depositing chemical alloy layers comprising alkali materials and an semiconductor layer formed by the delivery of type I, III and VI metals, where said alkali materials and said semiconductor layer are deposited upon a substrate.

37) The method of claim 36, wherein said substrate is chosen from a group of materials comprising metal, stainless steel, plastic, glass, and polymer material.

38) The method of claim 36, wherein said substrate is magnetically permeable.

39) The method of claim 36, wherein said substrate is titanium plated with nickel.

40) The method of claim 36, wherein said substrate is stainless steel plated with titanium and further plated with nickel.

41) The method of claim 36, wherein said substrate is plastic with a molybdenum coating.

42) A photovoltaic device made by providing a stainless steel foil substrate to an apparatus for treating the substrate, where the treating is deposition of a plurality of thin layers comprising of a back contact layer, a mixed phase semiconductor source layer, an precursor p-type absorber layer, an n-type junction layer, an intrinsic transparent oxide layer and an conducting transparent oxide layer.

43) A photovoltaic device of claim 42, wherein said a mixed phase semiconductor source layer is formed by depositing chemical alloy layers comprising alkali materials and a semiconductor layer formed by the delivery of type I, III and VI metals.

44) A method for the creation of an mixed phase semiconductor source layer wherein alkali materials and a semiconductor layer are separately synthesized, and then mixed, and then deposited on a substrate.

45) The method of claim 44 wherein said semiconductor layer is formed by the delivery of type I, III and VI precursor metals.

46) The method of claim 44 wherein said alkali materials are Na-VII or Na₂-VII.

47) The method of claim 44 wherein said mixture is deposited at ambient temperature and a pressure of 10⁻⁶-10⁻² torr.

48) The method of claim 44 wherein said semiconductor layer and said alkali materials are thermally treated at a temperature of 400° C.-600° C.

49) The method of claim 44 wherein the thickness of said mixed phase semiconductor source layer is between 150 and 500 nm.

50) The method of claim 44 wherein said mixed phase semiconductor source layer contains an alkali metal content of 5.0 to about 15.0 wt %.

51) A method for the creation of an mixed phase semiconductor source layer wherein alkali materials and a semiconductor layer are separately synthesized, and then co-deposited on a substrate.

52) The method of claim 51 wherein said semiconductor layer is formed by the delivery of type I, III and VI precursor metals.

53) The method of claim 51 wherein said alkali materials are Na-VII or Na₂-VII.

54) The method of claim 51 wherein said alkali materials and semiconductor layer are deposited at ambient temperature and a pressure of 10⁻⁶-10⁻² torr.

55) The method of claim 51 wherein said semiconductor layer and said alkali materials are thermally treated at a temperature of 400° C.-600° C.

56) The method of claim 51 wherein the thickness of said mixed phase semiconductor source layer is between 150 and 500 nm.

57) The method of claim 51 wherein said mixed phase semiconductor source layer contains an alkali metal content of 5.0 to about 15.0 wt %.

58) A method for the creation of an mixed phase semiconductor source layer wherein alkali materials and a semiconductor layer are co-deposited on a substrate and then synthesized into an alloy mixture.

59) The method of claim 58 wherein said semiconductor layer is formed by the delivery of type I, III and VI precursor metals.

60) The method of claim 58 wherein said alkali materials are Na-VII or Na₂-VII.

61) The method of claim 58 wherein said alkali materials and semiconductor layer are deposited at ambient temperature and a pressure of 10⁻⁶-10⁻² torr.

62) The method of claim 58 wherein said semiconductor layer and said alkali materials are thermally treated at a temperature of 400° C.-600° C.

63) The method of claim 58 wherein the thickness of said mixed phase semiconductor source layer is between 150 and 500 nm.

64) The method of claim 58 wherein said mixed phase semiconductor source layer contains an alkali metal content of 5.0 to about 15.0 wt %.

65) A method for the creation of an mixed phase semiconductor source layer wherein alkali materials and a semiconductor layer are sequentially deposited and then synthesized into an alloy mixture.

66) The method of claim 65 wherein said semiconductor layer is formed by the delivery of type I, III and VI precursor metals.

67) The method of claim 65 wherein said alkali materials are Na-VII or Na₂-VII.

68) The method of claim 65 wherein said alkali materials and semiconductor layer are deposited at ambient temperature and a pressure of 10⁻⁶-10⁻² torr.

69) The method of claim 65 wherein said semiconductor layer and said alkali materials are thermally treated at a temperature of 400° C.-600° C.

70) The method of claim 65 wherein the thickness of said mixed phase semiconductor source layer is between 150 and 500 nm.

71) The method of claim 65 wherein said mixed phase semiconductor source layer contains an alkali metal content of 5.0 to about 15.0 wt %.

72) A method for the creation of an mixed phase semiconductor source layer wherein alkali materials and a semiconductor layer are synthesized separately, sequentially deposited on a substrate, and then alloyed with a thermal treatment.

73) The method of claim 72 wherein said semiconductor layer is formed by the delivery of type I, III and VI precursor metals.

74) The method of claim 72 wherein said alkali materials are Na-VII or Na₂-VII.

75) The method of claim 72 wherein said alkali materials and semiconductor layer are deposited at ambient temperature and a pressure of 10⁻⁶-10⁻² torr.

76) The method of claim 72 wherein said semiconductor layer and said alkali materials are thermally treated at a temperature of 400° C.-600° C.

77) The method of claim 72 wherein the thickness of said mixed phase semiconductor source layer is between 150 and 500 nm.

78) The method of claim 72 wherein said mixed phase semiconductor source layer contains an alkali metal content of 5.0 to about 15.0 wt %.
